(19) United States
(12) Patent Application Publication
(10) Pub. No.: US 2020/0198403 A1
(43) Pub. Date: Jun. 25, 2020

(54) PNEUMATIC TIRE

(71) Applicant: TOYO TIRE CORPORATION, Itami-shi (JP)

(72) Inventor: Kazuo Shimomura, Itami-shi (JP)

(73) Assignee: TOYO TIRE CORPORATION, Itami-shi (JP)

(21) Appl. No.: 16/711,795

(22) Filed: Dec. 12, 2019

(30) Foreign Application Priority Data
Dec. 21, 2018 (JP) 2018-240181

(51) Int. Cl. B60C 9/26; B60C 15/06; B60C 9/02; B60C 13/00

(52) U.S. Cl. CPC B60C 9/26; B60C 15/0628; B60C 13/009; B60C 13/003; B60C 9/0292

(57) ABSTRACT

A pneumatic tire includes bead cores, a carcass ply and a belt. The carcass ply includes: a first ply having a central portion positioned inward of the belt in the tire radial direction, a pair of side portions extending inward from opposite ends of the central portion in the tire radial direction, and folded-up portions extending from the respective side portions, being folded up around the respective bead cores; and a second ply being discontinuous and disposed outward of the first ply in the tire radial direction, having a pair of ply pieces provided with inner ends positioned on respective sides of the central portion of the first ply, side portions extending inward from the respective inner ends in the tire radial direction, and folded-up portions extending from the respective side portions, being folded up around the respective bead cores. The first ply has a ply-overlapping portion.

### CROSS-REFERENCE TO RELATED APPLICATIONS

This application claims priority of Japanese Patent Application No.: 2018-240181 filed on Dec. 21, 2018, the content of which is incorporated herein by reference.

### BACKGROUND OF THE INVENTION

### Technical Field

The present invention relates to a pneumatic tire.

### Related Art

Conventionally, there is known a pneumatic tire including a carcass that is formed of at least one layer including a plurality of organic fiber cords or metal cords and that has a split portion split in a tread portion (e.g., refer to Japanese Patent Application Laid-Open No. 2010-111224).

However, the conventional pneumatic tire is configured such that the split portion of the carcass is only reinforced by a carcass split-portion reinforcing layer made of a thermoplastic elastomer. For this reason, it cannot be said that countermeasures for lifting during cornering are sufficient.

### SUMMARY

It is an object of the present invention to provide a pneumatic tire that can prevent lifting during cornering despite having a carcass ply split in a tread portion.

As means for solving the above-mentioned problems, the present invention provides a pneumatic tire including: bead cores disposed on respective sides in a tire width direction; a carcass ply stretched between the bead cores; and a belt disposed outward of the carcass ply in a tire radial direction, the carcass ply including: a first ply having a central portion positioned inward of the belt in a tire radial direction, a pair of side portions extending inward from opposite ends of the central portion in the tire radial direction, and folded-up portions extending from the respective side portions, being folded up around the respective bead cores; and a second ply being discontinuous and disposed outward of the first ply in the tire radial direction, having a pair of ply pieces provided with inner ends positioned on respective sides of the central portion of the first ply, side portions extending inward from the respective inner ends in the tire radial direction, and folded-up portions extending from the respective side portions, being folded up around the respective bead cores, the first ply having a ply-overlapping portion provided between the inner ends of the pair of ply pieces.

This structure does not cause the second ply to be positioned in the center portion in the tire width direction, so that weight reduction can be achieved. In addition, the first ply has the ply-overlapping portion to increase in rigidity, so that a ground contact surface is prevented from lifting in a central portion in the tire width direction even during cornering.

Preferably, a relationship, 5%≤W1/W2≤60%, is satisfied, where W1 is a dimension in the tire width direction of the ply-overlapping portion and W2 is an interval between the inner ends of the ply pieces.

Preferably, the first ply includes a pair of ply pieces having inner end portions positioned in a central portion in the tire width direction and a pair of side portions extending toward the respective bead cores, and the ply-overlapping portion is formed by overlapping the inner end portions of the ply pieces of the first ply.

The first ply may be stretched between the bead cores, and the ply-overlapping portion may be formed of a third ply piece provided separately from the first ply.

Preferably, the first ply and the second ply are strips in which a plurality of cords is disposed parallel to each other and covered with rubber, and the cords of the first ply and the second ply extend in a direction orthogonal to the tire circumferential direction.

Preferably, an adhesive tape is disposed in the ply-overlapping portion.

This structure enables the ply-overlapping portion to further be increased in rigidity to suppress lifting during cornering.

According to the present invention, despite the structure with the ply discontinuous in the central portion in the tire width direction, lifting in the central portion during cornering can be prevented.

### BRIEF DESCRIPTION OF THE DRAWINGS

The foregoing and the other features of the present invention will become apparent from the following description and drawings of an illustrative embodiment of the invention in which:

FIG. 1 is a meridian cross-sectional view of a pneumatic tire according to an embodiment of the present invention;

FIG. 2 is a meridian cross-sectional view of a tread portion and its surroundings of a pneumatic tire according to an embodiment of the present invention;

FIG. 3 is an enlarged view of portion III of FIG. 1;

FIG. 4 is an enlarged view of portion IV of FIG. 1;

FIG. 5 is a meridian cross-sectional view illustrating a part of a tread portion of a pneumatic tire according to another embodiment of the present invention; and

FIG. 6 is a meridian cross-sectional view illustrating a part of a tread portion of a pneumatic tire according to yet another embodiment of the present invention.

### DETAILED DESCRIPTION OF EMBODIMENTS

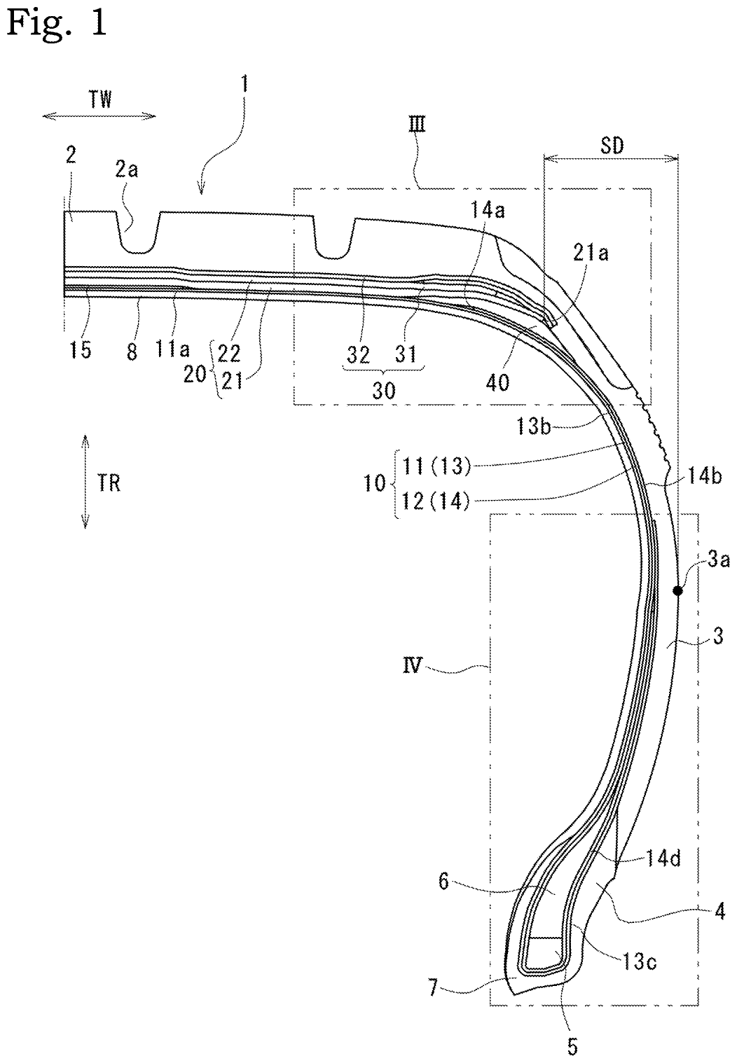

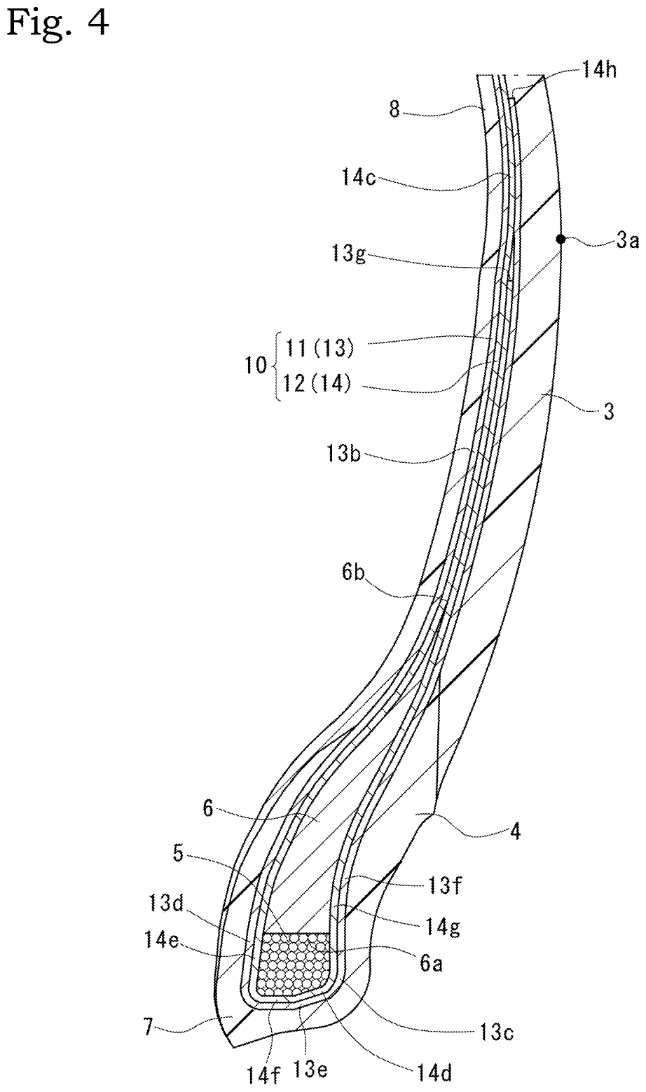

FIGS. 1 to 4 each illustrate a pneumatic tire (hereinafter referred to as a “tire”) 1 made of rubber according to an embodiment of the present invention.

A tire 1 includes a tread portion 2, a pair of sidewall portions 3, and a pair of bead portions 4 in a ring shape.

The tread portion 2 extends in the tire width direction (indicated by the symbol TW in FIG. 1). A groove 2a is provided on the tread portion 2 surface, i.e., a tread surface.

The pair of sidewall portions 3 extends inward from opposite ends of the tread portion 2 in the tire radial direction (indicated by the symbol TR in FIG. 1).

The pair of bead portions 4 is disposed in radially inner end portions of the respective pair of sidewall portions 3. Each of the bead portions 4 includes a bead core 5 and a bead filler 6. The bead core 5 includes a great number of steel wires bundled in a ring shape. The bead filler 6 is formed in a ring shape and is made of rubber harder than rubber constituting the tread portion 2 and the sidewall portion 3. The bead filler 6 includes a base end 6a disposed adjacent to a radially outer side of the bead core 5, and a leading end 6b opposite to the base end 6a, and extends radially outward from the base end 6a toward the leading end 6b in a tapered shape. Each of the bead portions 4 includes a strip rubber 7 provided wrapping the bead core 5 and the bead filler 6.

The tire 1 includes a carcass 10 stretched between the bead portions 4 in a toroidal shape. The carcass 10 of the present embodiment includes a first carcass ply (hereinafter referred to as a “first ply”) 11 and a second carcass ply (hereinafter referred to as a “second ply”) 12. The second ply 12 has a cut-out portion 14b. The first and second plies 11 and 12 will be described in detail below. An inner liner 8 is provided inside the carcass 10, i.e., on the innermost peripheral surface of the tire 1.

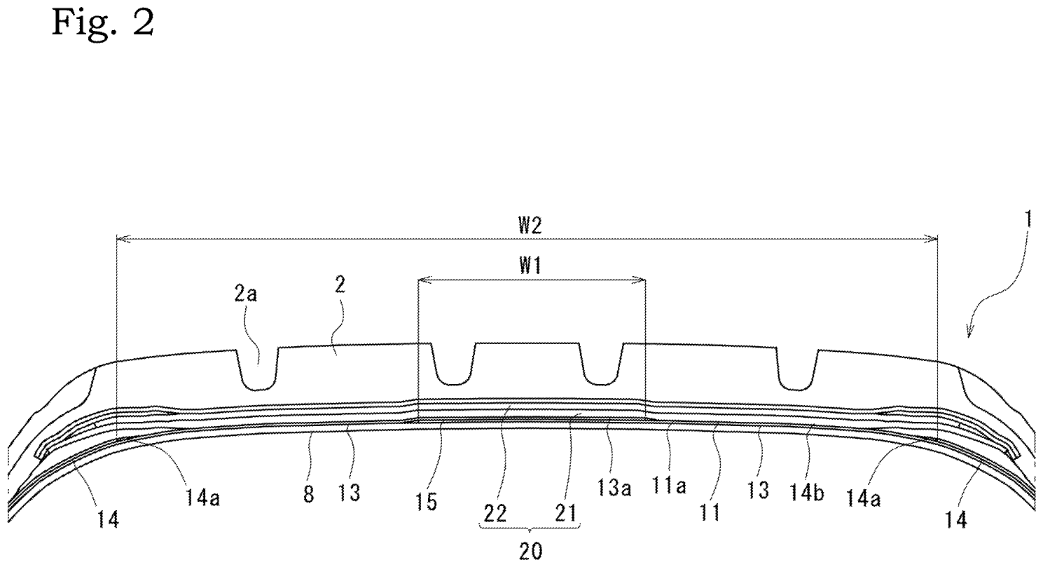

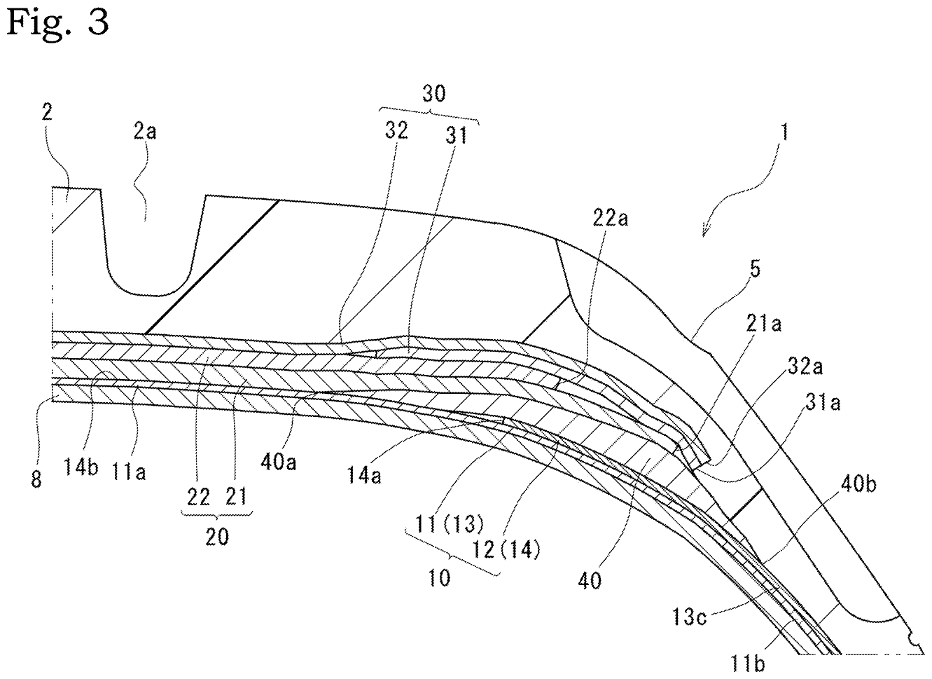

Referring to FIGS. 2 and 3, a belt layer 20 being endless is provided in the tread portion 2, more specifically, between the carcass 10 and the tread portion 2. In the present embodiment, the belt layer 20 includes two belts 21 and 22. The belt 21 is disposed adjacent to a radially outer side of the carcass 10, and the belt 22 is disposed adjacent to a radially outer side of the belt 21. In the present embodiment, the belt 21 in a lower layer has a dimension in the tire width direction more than a dimension of the belt 22 in an upper layer in the tire width direction, and the belt 21 has ends 21a positioned outward of respective ends 22a of the belt 22 in the tire width direction. The belts 21 and 22 are each formed by covering belt cords made of steel or organic fiber with rubber. The belt layer 20 may be composed of one belt or may be composed of three or more belts.

A cap layer 30 being endless is provided adjacent to a radially outer side of the belt layer 20. The cap layer 30 of the present embodiment includes a pair of edge plies 31 being narrow that is configured to directly cover any one of sets of the ends 21a and 22a of the corresponding belts 21 and 22. The cap layer 30 of the present embodiment also includes a cap ply 32 being wide that is disposed adjacent to a radially outer side of the edge plies 31 and that is configured to cover the entire belts 21 and 22 including the ends 21a and 22a with one sheet. The cap layer 30 may include one ply, or three or more plies. The cap layer 30 may be eliminated.

A pair of pads 40 made of rubber, being endless, is interposed between respective outer end portions of the belt layer 20 in the tire width direction and the carcass layer 10. The pad 40 has a cross-sectional shape of a flat triangular shape. The ends 21a and 22a of the corresponding belts 21 and 22, an end 31a of the edge ply 31 outward in the tire width direction, and an end 32a of the cap ply 32 in the tire width direction are set to be positioned in a region between an end 40a of the pad 40 outward in the tire width direction and an end 40b of the pad 40 inward in the tire width direction, i.e., in a region with the pad 40 existing. The pad 40 may be eliminated.

Hereinafter, the first and second plies 11 and 12 constituting the carcass 10 will be described.

The first ply 11 includes a pair of first ply pieces 13 that partially overlaps each other. As described above, the second ply 12 is a discontinuous ply having the cut-out portion 14b and includes a pair of second ply pieces 14. The first ply pieces 13 and the second ply pieces 14 are each a belt-like sheet with a plurality of cords disposed parallel to each other at intervals and covered with rubber.

The first ply pieces 13 and the second ply pieces 14 each may have an identical modulus (stress generated when a predetermined strain is applied) or a different modulus. The first ply pieces 13 and the second ply pieces 14 also may have an identical breaking strength (tensile load at which breaking occurs) or a different breaking strength. The case where the first ply pieces 13 are different in modulus and breaking strength from the second ply pieces 14 will be described in detail below.

The first ply piece 13 of the first ply 11 has an inner end portion 13a positioned in a central portion in the tire width direction and extends from there toward the corresponding one of the bead cores 5. Each of the first ply pieces 13 on an inner end portion 13a side is disposed in the tread portion 2 to constitute a central portion 11a. Inner end portions 13a of the respective first ply pieces 13 overlap each other in the central portion 11a in the tire width direction, and this overlapping portion constitutes a ply-overlapping portion 15. When a dimension of the ply-overlapping portion 15 in the tire width direction is indicated as W1 and an interval between inner ends 14a of the respective second ply pieces 14 described below in the tire width direction is indicated as W2, a relationship, 5%≤W1/W2≤60%, is satisfied. When the width dimension of the ply-overlapping portion 15 is set as described above, wiping in the tire width direction is suppressed in the central portion in the tire width direction, and thus a ground contact surface can be prevented from lifting during cornering. Each of the first ply pieces 13 includes a side portion 13b extending inward in the tire radial direction. The side portion 13b is disposed in the sidewall portion 3. In addition, each of the first ply pieces 13 includes a folded-up portion 13c that extends inward from the side portion 13b in the tire radial direction, and to be stretched around the corresponding one of the bead cores 5. The folded-up portion 13c includes an inner portion 13d extending along inner surfaces of the bead filler 6 and the bead core 5. The folded-up portion 13c also includes an inner diameter portion 13e extending along a lower surface of the bead core 5. The folded-up portion 13c further includes an outer portion 13f extending along outer surfaces of the bead core 5 and the bead filler 6. The outer portion 13f has an end being a folded-up end 13g. The folded-up end 13g is positioned near a tire maximum width position 3a of the sidewall portion 3.

Each of the second ply pieces 14 of the second ply 12 is disposed adjacent to a radially outer side of the first ply 11. Each of the second ply pieces 14 has the inner end 14a disposed between the belt layer 20 and the inner end portion 13a of the first ply piece 13. The pad 40 is interposed between the inner end 14a and the belt layer 20. The second ply piece 14 is set to have the inner end 14a at a position in the tire width direction in an outer region of the tread portion 2 in the tire width direction, more specifically, in a region inward of both the ends 21a and 22a of the corresponding belts 21 and 22 constituting the belt layer 20, in the tire width direction. The cut-out portion 14b is provided in a central region in the tread portion 2 in the tire width direction, more specifically, in a region between inner ends 14a of the respective pair of second ply pieces 14. In the cut-out portion 14b, the second ply 12 does not exist, and only the central portion 11a of the first ply 11 exists.

The second ply piece 14 further includes a side portion 14c and a folded-up portion 14d. The side portion 14c extends inward from the inner end 14a in the tire radial direction. The side portion 14c is disposed adjacent to the side portion 13b of the first ply piece 13 on its outer side in the tire width direction. The folded-up portion 14d includes an inner portion 14e that extends radially inward along an inner surface of the tire width direction of the bead filler 6 in the tire radial direction and overlies the inner portion 13d of the first ply piece 13 on an inner surface side of the bead core 5. The folded-up portion 14d also includes an inner diameter portion 14f overlying the inner diameter portion 13e of the first ply piece 13 on an inner diameter side of the bead core 5. In addition, the folded-up portion 14d includes an outer portion 14g overlying the outer portion 13f of the first ply piece 13 on an outer surface side of the bead core 5. The outer portion 14g has an end being a folded-up end 14h. The folded-up end 14h is positioned outward of the folded-up end 13g of the first ply piece 13 in the tire radial direction.

According to the pneumatic tire configured as described above, the following effects can be obtained.

The first ply 11 is composed of the pair of first ply pieces 13 that forms a ply-overlapping portion 15 in a central portion on a radially inner side. This enables partial reinforcement of the first ply 11 to be achieved. During cornering, an outer portion of the tread portion 2 in the tire width direction (outer portion), being in contact with a road surface, has a ground contact pressure larger than that of an inner portion thereof in the tire width direction (inner portion), being in contact with the road surface. In this case, the outer portion is less likely to be displaced. On the other hand, the inner portion having the ground contact pressure smaller than the outer portion is likely to be displaced outward in the tire width direction. While this causes the central portion 11a of the first ply 11 to be likely to be deformed, the deformation is suppressed due to presence of the ply-overlapping portion 15. That is, the central portion of the first ply 11 is less likely to be lifted, so that an appropriate shape can be maintained. As a result, cornering performance can be improved.

The second ply 12 is a discontinuous ply provided with the pair of second ply pieces 14, and there is provided the cut-out portion 14b with no ply existing between the inner ends 14a of the respective pair of second ply pieces 14. Employing the second ply 12 with the cut-out portion 14b as described above enables weight reduction as compared with the second ply 12 formed of one continuous ply.

Throughout the sidewall portion 3, two layers of plies, i.e., the side portion 13b of the first ply piece 13 and the side portion 14c of the second ply piece 14, are disposed. In a region near the bead core 5 in the sidewall portion 3, further one layer of a ply, i.e., the folded-up portion 14d of the second ply piece 14, is disposed. As described above, providing the two or three layers of plies in the sidewall portion 3 secures required cut resistance. Providing the two or three layers of plies also secures required rigidity in the sidewall portion 3.

Next, the case where the first ply piece 13 and the second ply piece 14 each have a different modulus and a different breaking strength will be described.

The first ply piece 13 may have a modulus lower than a modulus of the second ply piece 14. In the carcass ply 10, generally, decrease in modulus tends to reduce weight, and increase in modulus tends to increase weight. While the second ply 12 has the cut-out portion 14b, the first ply 11 has the central portion 11a including the ply-overlapping portion 15 in the tread portion 2. Compared with the side portion 13b of the first ply piece 13 and the second ply piece 14 of the second ply 12, the central portion 11a of the first ply 11 contributes less to improvement in rigidity and cut resistance. When the first ply 11 having the central portion 11a including the ply-overlapping portion 15 as described above has a lower modulus than the second ply piece 14 of the second ply 12 and thus is relatively light in weight, further weight reduction can be achieved without impairing rigidity and cut resistance.

The first ply piece 13 may have a breaking strength lower than a breaking strength of the second ply piece 14. In the carcass ply 10, generally, decrease in breaking strength tends to reduce weight, and increase in breaking strength tends to increase weight. While the second ply 12 has the cut-out portion 14b, the first ply 11 has the ply-overlapping portion 15 in the tread portion 2. Compared with the side portion 13b of the first ply piece 13 and the second ply piece 14 of the second, the inner end portion 13a of the first ply piece 13 contributes less to improvement in rigidity and cut resistance. When the first ply 13 having the inner end portion 13a as described above has a lower breaking strength than the second ply piece 14 and thus is relatively light in weight, further weight reduction can be achieved without impairing rigidity and cut resistance.

When the first ply piece 13 is made different from the second ply piece 14 in at least one of cord material, cord diameter, the number of ends, rubber hardness, and rubber thickness, a modulus of the first ply piece 13 can be set lower than a modulus of the second ply piece 14, or a breaking strength of the first ply piece 13 can be set lower than a breaking strength of the second ply piece 14.

The cord diameter, the number of ends, the rubber hardness, and the rubber thickness generally have the following tendencies. First, increase in the cord diameter increases the modulus and the breaking strength. Increase in the number of ends increases the modulus and the breaking strength. Increase in the rubber hardness increases the modulus and the breaking strength. Increase in the rubber thickness increases the modulus and the breaking strength.

The cord material has a higher modulus in the order of metal (steel), aramid, rayon, polyester, and nylon. The cord material also has a higher breaking strength in the order of metal (steel), aramid, nylon, polyester, and rayon.

In addition, the present invention is not limited to the structure described in the above embodiment, and various modifications are available.

While in the above embodiment, the ply-overlapping portion 15 is formed by overlapping the inner end portions 13a of the respective first ply pieces 13, the ply-overlapping portion 15 can also be configured as follows.

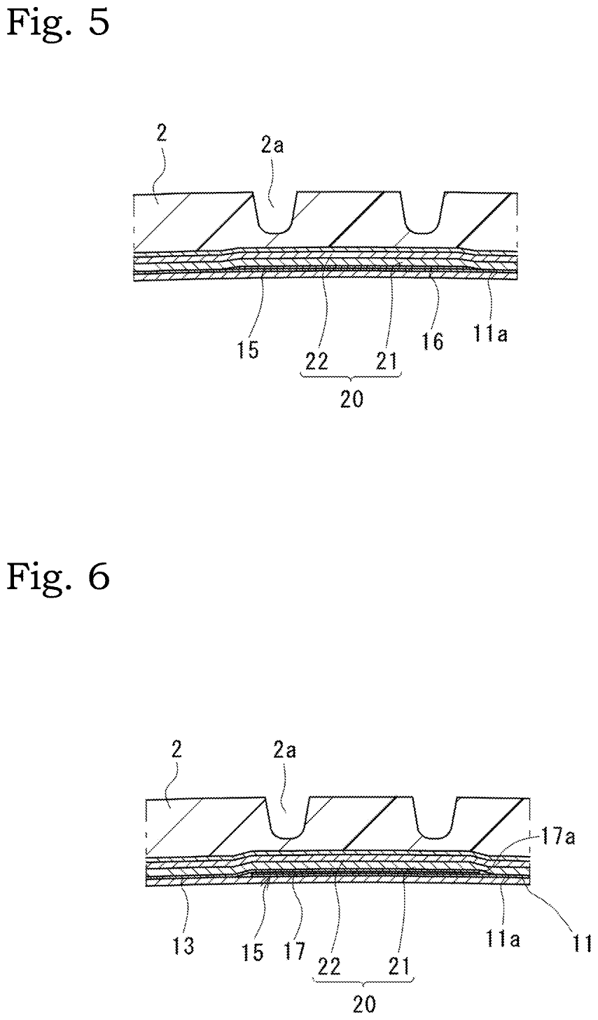

FIG. 5 illustrates the first ply 11 that is formed of a normal single ply having no cut-out portion. The central portion 11a of the first ply 11 includes a third ply 16 disposed adjacent to its radially inner side. Then, the third ply 16 forms a ply-overlapping portion. Here, the third ply 16 is disposed at a position corresponding to two main grooves 2a formed in the tire circumferential direction in a central portion of the tread portion 2 in the tire width direction. Accordingly, when the tread portion 2 comes into contact with the ground, the central portion in the tire width direction with a maximum ground contact pressure can be reinforced. Third ply 16 can be disposed not only at one place but also at a plurality of places. The third ply 16 can be freely set to have a width and the number thereof within a range without impeding weight reduction.

While in the above embodiment, the inner end portions 13a of the first ply pieces 13 are merely overlapped, they may be bonded together with a tape 17 having adhesiveness on both surfaces as illustrated in FIG. 6. As the tape 17, an adhesive tape having an elastic modulus of 10 MPa or more and 50 MPa or less, and an adhesive strength of 4.9 N or more is used. The tape 17 having an elastic modulus less than 10 MPa causes a binding force between the first ply 11 and the second ply 12 to be insufficient. On the other hand, the tape 17 having an elastic modulus more than 50 MPa causes the binding force by the tape 17 to be too large and flexibility to be impaired. In addition, the tape 17 having an adhesive strength less than 4.9 N on its both sides causes a bonding state between the tape 17 and the first ply 11 or between the tape 17 and the second ply 12 to be insufficient, so that the first ply 11 and the second ply 12 cannot obtain desired tension as a whole.

The tape 17 has an inner end at a position in the tire width direction, substantially corresponding to a position of both ends (ground contact ends) of the tread portion. The tape 17 also has an outer end position 17a in the tire width direction that is set not to exceed 50% of the shortest distance SD in the tire width direction between the end 21a of a wider belt and the tire maximum width position 3a.

While in the above embodiment, the carcass ply 10 is composed of the first and second plies 11 and 12, a ply having a cut-out portion, similar to the second ply 12, and a normal ply similar to the first ply 11 may be further provided. There may be provided a plurality of tapes 17 for bonding the individual side portions 13b of the first ply pieces 13 to the respective second ply pieces 14.

What is claimed is:

1. A pneumatic tire comprising:
bead cores disposed on respective sides in a tire width direction;
a carcass ply stretched between the bead cores; and
a belt disposed outward of the carcass ply in a tire radial direction, wherein
the carcass ply includes:
a first ply having a central portion positioned inward of the belt in a tire radial direction, a pair of side portions extending inward from opposite ends of the central portion in the tire radial direction, and folded-up portions extending from the respective side portions and being folded up around the respective bead cores; and
a second ply being discontinuous and disposed outward of the first ply in the tire radial direction, having a pair of ply pieces provided with inner ends positioned on respective sides of the central portion of the first ply, side portions extending inward from the respective inner ends in the tire radial direction, and folded-up portions extending from the respective side portions, being folded up around the respective bead cores, and
the first ply has a ply-overlapping portion provided between the inner ends of the pair of ply pieces.

2. The pneumatic tire according to claim 1, wherein
a relationship, 5%≤W1/W2≤60%, is satisfied, where W1 is a dimension in the tire width direction of the ply-overlapping portion and W2 is an interval between the inner ends of the ply pieces.

3. The pneumatic tire according to claim 1, wherein
the first ply includes a pair of ply pieces having inner end portions positioned in a central portion in the tire width direction and a pair of side portions extending toward the respective bead cores, and
the ply-overlapping portion is formed by overlapping the inner end portions of the ply pieces of the first ply.

4. The pneumatic tire according to claim 1, wherein
the first ply is stretched between the bead cores, and
the ply-overlapping portion is formed of a third ply piece provided separately from the first ply.

5. The pneumatic tire according to claim 1, wherein
the first ply and the second ply are strips in which a plurality of cords is disposed parallel to each other and covered with rubber, and the cords of the first ply and the second ply extend in a direction orthogonal to a tire circumferential direction.

6. The pneumatic tire according to claim 1, wherein
an adhesive tape is disposed in the ply-overlapping portion.

7. The pneumatic tire according to claim 2, wherein
the first ply includes a pair of ply pieces having inner end portions positioned in a central portion in the tire width direction and a pair of side portions extending toward the respective bead cores, and
the ply-overlapping portion is formed by overlapping the inner end portions of the ply pieces of the first ply.

8. The pneumatic tire according to claim 2, wherein
the first ply is stretched between the bead cores, and
the ply-overlapping portion is formed of a third ply piece provided separately from the first ply.

9. The pneumatic tire according to claim 2, wherein
the first ply and the second ply are strips in which a plurality of cords is disposed parallel to each other and covered with rubber, and the cords of the first ply and the second ply extend in a direction orthogonal to a tire circumferential direction.

10. The pneumatic tire according to claim 3, wherein
the first ply and the second ply are strips in which a plurality of cords is disposed parallel to each other and covered with rubber, and the cords of the first ply and the second ply extend in a direction orthogonal to a tire circumferential direction.

11. The pneumatic tire according to claim 4, wherein
the first ply and the second ply are strips in which a plurality of cords is disposed parallel to each other and covered with rubber, and the cords of the first ply and the second ply extend in a direction orthogonal to a tire circumferential direction.

12. The pneumatic tire according to claim 2, wherein
an adhesive tape is disposed in the ply-overlapping portion.

13. The pneumatic tire according to claim 3, wherein
an adhesive tape is disposed in the ply-overlapping portion.

14. The pneumatic tire according to claim 4, wherein
an adhesive tape is disposed in the ply-overlapping portion.

15. The pneumatic tire according to claim 5, wherein
an adhesive tape is disposed in the ply-overlapping portion.
